(19) United States
(12) Patent Application Publication
(10) Pub. No.: US 2019/0303447 A1
(43) Pub. Date: Oct. 3, 2019

(54) METHOD AND SYSTEM FOR IDENTIFYING TYPE OF A DOCUMENT

(71) Applicant: Wipro Limited, Bangalore (IN)

(72) Inventors: Ghulam Mohiuddin Khan, Bangalore (IN); Gopichand Agnihotram, Bangalore (IN)

(73) Assignee: Wipro Limited

(21) Appl. No.: 15/938,789

(22) Filed: Mar. 28, 2018

(30) Foreign Application Priority Data
Mar. 28, 2018 (IN) 201841011593

(51) Int. Cl. G06F 17/30; G06K 9/00

(52) U.S. Cl. CPC G06F 17/30011; G06F 17/3053; G06K 2209/01; G06K 9/00469; G06K 9/00483

(57) ABSTRACT

Disclosed herein is a method and system for identifying type of an input document in real-time. In an embodiment, visual features and keywords of the input document are compared with reference visual features and reference keywords extracted from plurality of predetermined document types for computing a relative similarity score for the input document. Subsequently, one or more best-match document types are identified among the plurality of predetermined document types based on the relative similarity score of the input document. Thereafter, visual features and keywords of the input document are compared with global and local characteristics of the best-match document types for identifying the type of the input document. In an embodiment, the present disclosure helps in recognizing type of a document prior to digitizing the document, and thereby helps in storing the digitized documents in correct formats and appropriate storage directories.

### TECHNICAL FIELD

The present subject matter is, in general, related to feature extraction and more particularly, but not exclusively, to a method and system for identifying type of a document in real-time.

### BACKGROUND

With rapid development of digital and Internet technologies, digitizing and storing legacy documents and/or forms and their details in a digital form on digital devices/storage systems has become a necessity. Storing the documents in the digital form would reduce burden of maintaining an offline storage of documents, and would also enhance the ease with which a document can be retrieved and accessed when required. Presently, there are billions of forms stored in various institutions such as government offices, academic organizations and private workplaces, which are required to be digitized, that is, converted into the digital form.

The existing systems which are used for digitizing various types of legacy documents make use of scanned images of the legacy documents to digitize documents using techniques such as Optical Character Recognition (OCR). However, the existing methods do not consider type and/or nature of the document during the digitization process. Identifying the type and nature of the documents during the digitization process would help in improving accuracy of digitization by eliminating possibilities of character recognition errors. Further, identifying the type of the documents prior to digitization would also help in storing the digitized documents and associated details in appropriate and correct formats, within designated folders/directories.

The information disclosed in this background of the disclosure section is only for enhancement of understanding of the general background of the invention and should not be taken as an acknowledgement or any form of suggestion that this information forms the prior art already known to a person skilled in the art

### SUMMARY

One or more shortcomings of the prior art may be overcome, and additional advantages may be provided through the present disclosure. Additional features and advantages may be realized through the techniques of the present disclosure. Other embodiments and aspects of the disclosure are described in detail herein and are considered a part of the claimed disclosure.

Disclosed herein is a method for identifying type of a document in real-time. The method comprises extracting, by a document identification system, one or more visual features and one or more keywords from an input document. Subsequently, the method includes comparing each of the one or more visual features and each of the one or more keywords with one or more visual features and one or more keywords associated with plurality of predetermined document types. Further, a relative similarity score is computed for the input document based on the comparison. Upon computing the relative similarity score, one or more best-match document types, among the plurality of predetermined document types, for the input document are identified based on the relative similarity score of the input document. Finally, the type of the input document is identified by comparing the one or more visual features and the one or more keywords extracted from the input document with one or more global characteristics and one or more local characteristics associated with each of the one or more best-match document types.

Further, the present disclosure relates to a document identification system for identifying type of a document in real-time. The document identification system comprises a processor and a memory. The memory is communicatively coupled to the processor and stores processor-executable instructions, which on execution cause the processor to extract one or more visual features and one or more keywords from an input document. Further, the instructions cause the processor to compare each of the one or more visual features and each of the one or more keywords with one or more visual features and one or more keywords associated with plurality of predetermined document types. Subsequently, the instructions cause the processor to compute a relative similarity score for the input document based on the comparison. Upon computing the relative similarity score, the instructions cause the processor to identify one or more best-match document types, among the plurality of predetermined document types, for the input document based on the relative similarity score of the input document. Finally, the instructions cause the processor to identify the type of the input document based on comparison of the one or more visual features and the one or more keywords extracted from the input document with one or more global characteristics and one or more local characteristics associated with each of the one or more best-match document types.

Furthermore, the present disclosure relates to a non-transitory computer readable medium including instructions stored thereon that when processed by at least one processor cause a document identification system to perform operations comprising extracting one or more visual features and one or more keywords from an input document. Subsequently, the instructions cause the processor to compare each of the one or more visual features and each of the one or more keywords with one or more visual features and one or more keywords associated with plurality of predetermined document types. Further, the instructions cause the processor to compute a relative similarity score for the input document based on the comparison. Upon computing the relative similarity score, the instructions cause the processor to identify one or more best-match document types, among the plurality of predetermined document types, for the input document based on the relative similarity score of the input document. Finally, the instructions cause the processor to identify the type of the input document by comparing the one or more visual features and the one or more keywords extracted from the input document with one or more global characteristics and one or more local characteristics associated with each of the one or more best-match document types.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 illustrates an exemplary environment for identifying type of a document in real-time in accordance with some embodiments of the present disclosure;

FIG. 2 shows a detailed block diagram illustrating a document identification system in accordance with some embodiments of the present disclosure;

FIG. 3 shows an exemplary input document in accordance with some embodiments of the present disclosure;

FIG. 4 shows a flowchart illustrating a method of identifying type of a document in real-time in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a document identification system for identifying type of a document in real-time. In some embodiments, the method of present disclosure includes extracting one or more keywords and one or more visual features from an input document using a predetermined character recognition technique. Thereafter, the method may utilize a pre-trained multi-class classifier network to compute a relative similarity score for the input document by correlating each of the one or more keywords and each of the one or more visual features of the document with the one or more keywords and visual features of various predetermined document types.

Further, the relative similarity score of the input document may be used for identifying top ‘N’ best-matching document types among the predetermined document types. Finally, the type of the input document may be determined by comparing each of the one or more keywords and each of the one or more visual features of the input document with one or more global characteristics and one or more local characteristics of the best-matching document types. Thus, the instant disclosure helps in accurate identification of the type and nature of the input document, prior to digitization of the input document, and thereby ensures that the input document is stored in correct formats and correct directories after it is digitized.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

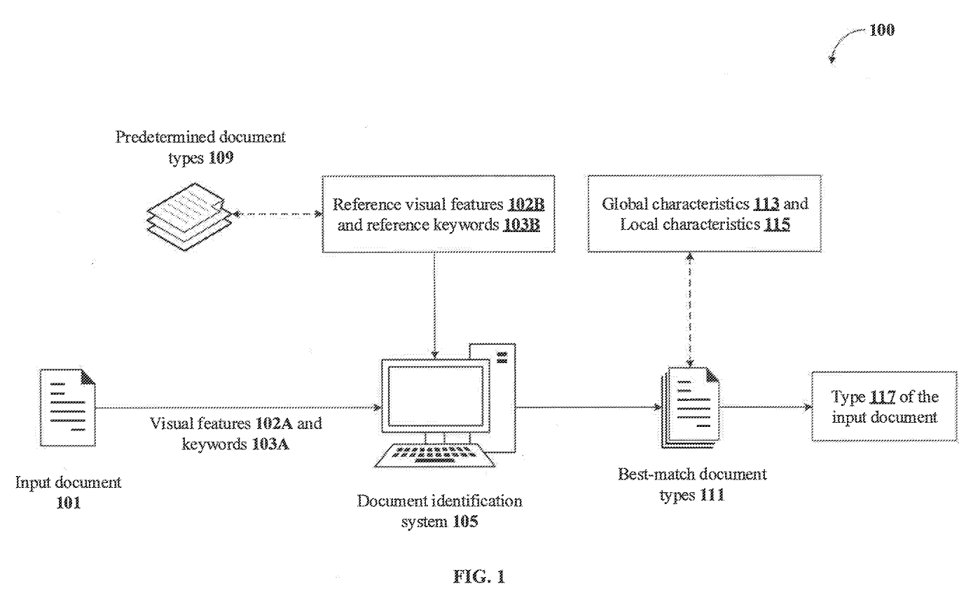

FIG. 1 illustrates an exemplary environment 100 for identifying type of a document in real-time in accordance with some embodiments of the present disclosure.

The environment 100 includes a document identification system 105, which receives an input document 101 and identifies type 117 of the input document 101. In an embodiment, the document identification system 105 may be a computing device such as a desktop computer, a laptop, a Personal Digital Assistant, a smartphone and the like, which may be configured to analyze and identify the type 117 of the input document 101 in accordance with the method of present disclosure. The input document 101 may be an electronic document such as a scanned document, a photograph of the document and the like, which may be received from one or more sources such as a document/image scanner, an image capturing device and the like, associated with the document identification system 105.

In an embodiment upon receiving the input document 101, the document identification system 105 may extract one or more visual features 102A and one or more keywords 103A from the input document 101 using a predetermined character recognition technique such as Optical Character Recognition (OCR) technique configured in the document identification system 105. As an example, the one or more visual features 102A may include, without limiting to, information related to location and pattern of each of lines, keywords, text boxes, check boxes, box sequences, tables, labels and logos present in the input document 101. Similarly, the one or more keywords 103A may include, without limiting to, text and/or phrases in the input document 101, which indicate nature and context of the input document 101.

In an embodiment, upon extracting the one or more visual features 102A and the one or more keywords 103A from the input document 101, the document identification system 105 may compare each of the one or more visual features 102A and each of the one or more keywords 103A of the input document 101 with one or more reference visual features 102B and one or more reference keywords 103B that are extracted from a plurality of predetermined document types 109. Further, based on the comparison, the document identification system 105 may compute a relative similarity score for the input document 101. In an embodiment, the relative similarity score of the input document 101 may indicate relative similarity of the input document 101 with respect to each of the plurality of predetermined document types 109.

In an embodiment, the relative similarity score may be computed by aggregating a visual similarity score and a textual similarity score assigned for the input document 101. The visual similarity score may be assigned by comparing each of the one or more visual features 102A of the input document 101 with each of the one or more reference visual features 102B of the plurality of predetermined document types 109. Similarly, the textual similarity score may be assigned to the input document 101 by comparing each of the one or more keywords 103A of the input document 101 with each of the one or more reference keywords 103B of the plurality of predetermined document types 109. In an embodiment, the visual similarity score and the textual similarity score for the input document 101 may be assigned using a pre-trained multi-class classifier configured in the document identification system 105. In an implementation, the pre-trained multi-class classifier may be trained using the one or more visual features and the one or more keywords 103A extracted from one or more documents that are filled with contents and one or more empty/non-filled documents of each of the plurality of predetermined document types 109.

In an embodiment, upon computing the relative similarity score for the input document 101, the document identification system 105 may identify one or more best-match document types 111 among the plurality of predetermined document types 109 based on the relative similarity score of the input document 101. As an example, one or more of the plurality of predetermined document types 109 may be identified as the one or more best-match document types 111 when the relative similarity score of the input document 101, in comparison to the one or more of the plurality of predetermined document types 109, is higher than a threshold similarity score.

In an embodiment, upon identifying the best-match document types 111 among the plurality of predetermined document types 109, the document identification system 105 may identify the type 117 of the input document 101 by comparing the one or more visual features 102A and the one or more keywords 103A extracted from the input document 101 with one or more global characteristics 113 and one or more local characteristics 115 associated with each of the one or more best-match document types 111. As an example, the one or more global characteristics 113 may indicate, without limitation, presence and count of each of lines, keywords, text boxes, check boxes, box sequences, tables, labels and logos in the one or more best-match document types 111. Similarly, the one or more local characteristics 115 may indicate, without limitation, location and pattern of each of one or more global characteristics 113 in the one or more best-match document types 111.

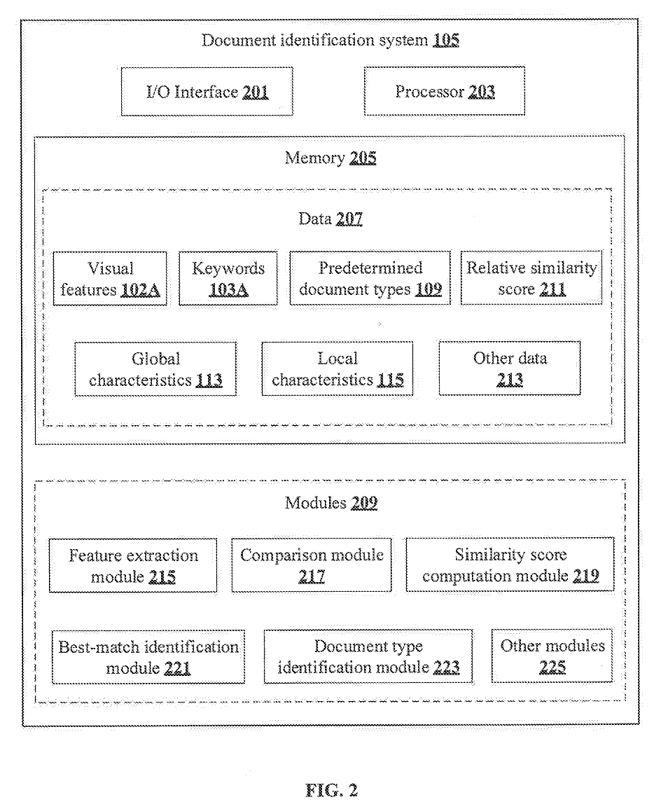

FIG. 2 shows a detailed block diagram illustrating a document identification system 105 in accordance with some embodiments of the present disclosure.

In an implementation, the document identification system 105 may include an I/O interface 201, a processor 203, and a memory 205. The I/O interface 201 may be configured to receive an input document 101 from one or more sources associated with the document identification system 105. The processor 203 may be configured to perform one or more functions of the document identification system 105 while identifying type 117 of the input document 101. The memory 205 may be communicatively coupled to the processor 203.

In some implementations, the document identification system 105 may include data 207 and modules 209 for performing various operations in accordance with embodiments of the present disclosure. In an embodiment, the data 207 may be stored within the memory 205 and may include information related to, without limiting to, visual features 102A, keywords 103A, predetermined document types 109, a relative similarity score 211, global characteristics 113, local characteristics 115 and other data 213.

In some embodiments, the data 207 may be stored within the memory 205 in the form of various data structures. Additionally, the data 207 may be organized using data models, such as relational or hierarchical data models. The other data 213 may store data, including the input document 101, information related to one or more best-match document types 111 and other temporary data and files generated by one or more modules 209 for performing various functions of the document identification system 105.

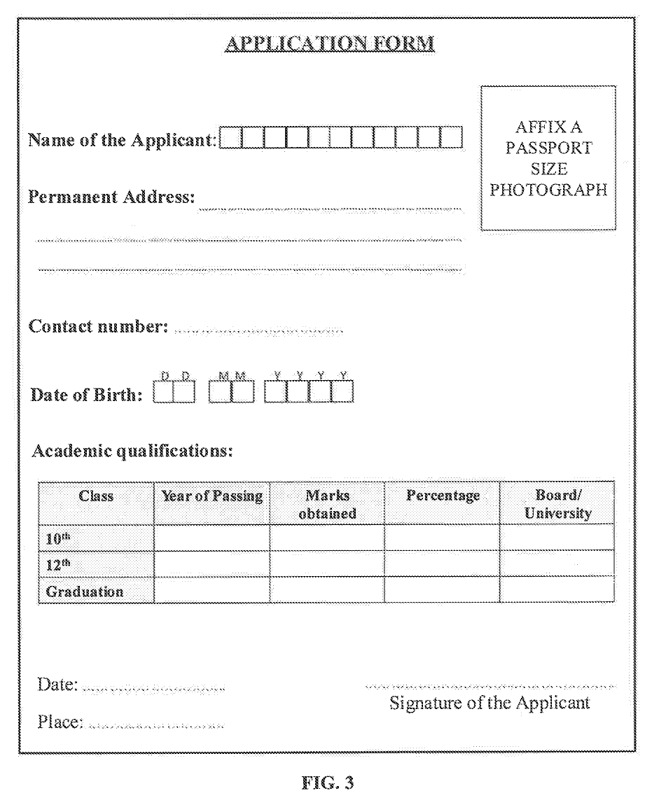

In an embodiment, the one or more visual features 102A may include, without limiting to, location, orientation and specific patterns in which one or more features such as lines, keywords, text boxes, check boxes, box sequences, tables, labels, and logos are present in the input document 101. For example, referring to the input document 101 shown in FIG. 3, the one or more visual features 102A that may be extracted from the input document 101 of FIG. 3 may include—a rectangular space on top-right corner of the document for affixing the photograph, a label at the top-center of the document, a table with 5 columns and 4 rows on the bottom half of the document and the like.

Similarly, the one or more keywords 103A may include, without limiting to, document-specific text characters, text phrases, and the like, which may be useful for identifying the context/content of the input document 101. As an example, the one or more keywords 103A that may be extracted from the input document 101 of FIG. 3 may include textual phrases such as—‘Name of the applicant’, ‘address’, ‘contact number’ ‘date of birth’, ‘academic qualification’, signature of the applicant’ and the like. In an embodiment, the or more keywords 103A may be unigrams, bigrams, trigrams and the like, and may be extracted using a keyword co-occurrence matrix. Further, one or more preconfigured similarity analysis techniques such as Spacy model or Wordnet may be used for determining one or more semantically similar words for the one or more keywords 103A extracted from the input document 101. Subsequently, each of the one or more keywords 103A and the associated one or more semantically similar words may be clustered into various clusters of similar words using a predetermined clustering technique such as K-means clustering or DB scan technique. Clustering of the one or more keywords 103A and the associated semantically similar words may help the document identification system 105 in differentiating the one or more keywords 103A of similar document types.

In an embodiment, the one or more visual features 102A and the one or more keywords 103A may be unique for each document type, and hence may be used for identifying a best-match document type for the input document 101. As an example, the visual feature—‘rectangular space on top-right corner of the document’, which is extracted from the input document 101 of FIG. 3 may be compared against the plurality of predetermined document types 109 for identifying the one or more best-match document types 111, which may comprise same/similar visual feature, that is, ‘the rectangular space on the top-right corner’. Similarly, a key phrase such as ‘Academic qualification’ may be compared against each of the plurality of predetermined document types 109, and the documents that comprise same or semantically similar keyword/key phrase may be identified as the best-match document type for the input document 101.

In an embodiment, the plurality of predetermined document types 109 may be pre-stored in the document identification system 105, and may be used as references for identifying the type 117 of the input document 101. The plurality of predetermined document types 109 may be collected from varied sources of multiple domains such as health care, education, finance, automobile and the like, so that the document identification system 105 may always identify the one or more best-match document types 111 for each type 117 of the input document 101.

In an embodiment, the relative similarity score 211 computed for the input document 101 may indicate a relative similarity of the input document 101 with each of the plurality of predetermined document types 109. As an example, on a scale of 0-10, the relative similarity score 211 for the input document 101, with respect to a predetermined document type ‘D’, may be assigned with a higher value, that is, say 8, when each or most of the one or more visual features 102A and the one or more keywords 103A of the input document 101 appear to match with the one or more reference visual features 102B and the one or more reference keywords 103B of the predetermined document type ‘D’. Likewise, the relative similarity score 211 for the input document 101 with respect to each of the plurality of predetermined document types 109 may be computed by comparing each of the one or more visual features 102A and each of the one or more keywords 103A of the input document 101 against the one or more reference visual features 102B and the one or more reference keywords 103B of each of the plurality of predetermined document types 109.

In an embodiment, one or more of the plurality of predetermined document types 109 may be identified as the one or more best-match document types 111 when the similarity score of the input document 101 with respect to the one or more of the plurality of predetermined documents is higher than a threshold similarity score. Suppose, if the threshold similarity score is 5, then each of the one or more document types that have resulted in a similarity score of more than 5 may be considered to be the one or more best-match document types 111 for the input document 101.

In an embodiment, the one or more global characteristics 113 may indicate, without limitation, presence and/or count of each of lines, keywords, text boxes, check boxes, box sequences, tables, labels and logos in the one or more best-match document types 111. Further, the one or more local characteristics 115 may indicate location and/or pattern of each of the one or more global characteristics 113 in the one or more best-match document types 111. As an example, consider an input document 101 which has a ‘logo’. Here, the global characteristic of the input document 101 may indicate that a ‘logo’ is present in the input document 101. Similarly, the local characteristic of the input document 101 may indicate that the ‘logo’ is located on the ‘top-center’ portion of the input document 101. Thus, the one or more global characteristics 113 and the one or more local characteristics 115 indicate characteristics that are specific to a document type, which in turn may be used for accurate identification of the type 117 of the input document 101, among the one or more best-match document types 111.

In an embodiment, each of the data 207 stored in the document identification system 105 may be processed by one or more modules 209 of the document identification system 105. In one implementation, the one or more modules 209 may be stored as a part of the processor 203. In another implementation, the one or more modules 209 may be communicatively coupled to the processor 203 for performing one or more functions of the document identification system 105. The modules 209 may include, without limiting to, a feature extraction module 215, a comparison module 217, a similarity score computation module 219, a best-match identification module 221, a document type identification module 223, and other modules 225.

As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 225 may be used to perform various miscellaneous functionalities of the document identification system 105. It will be appreciated that such modules 209 may be represented as a single module or a combination of different modules.

In an embodiment, the feature extraction module 215 may be used for extracting each of the one or more visual features 102A and each of the one or more keywords 103A from the input document 101. In an implementation, the feature extraction module 215 may be configured with a predetermined character recognition technique such as Optical Character Recognition (OCR) for extracting each of the one or more visual features 102A and each of the one or more keywords 103A from the input document 101.

In an embodiment, the comparison module 217 may be used for comparing each of the one or more visual features 102A and each of the one or more keywords 103A with the one or more reference visual features 102B and the one or more reference keywords 103B associated with the plurality of predetermined document types 109. In an embodiment, the similarity score computation module 219 may assign a visual similarity score and a textual similarity score for the input document 101 after completion of the comparison by the comparison module 217. The visual similarity score may be assigned based on the comparison of each of the one or more visual features 102A of the input document 101 with the one or more reference visual features 102B of each of the plurality of predetermined document types 109. Further, the textual similarity score may be assigned based on the comparison of each of the one or more keywords 103A in the input document 101 with the one or more reference keywords 103B associated with each of the plurality of predetermined document types 109. Finally, the similarity score computation module 219 may compute the relative similarity score 211 for the input document 101 by the visual similarity score and the textual similarity score for obtaining the relative similarity score 211 of the input document 101.

In an implementation, the similarity score computation module 219 may be configured with a pre-trained multi-class classifier, which is capable of correlating the one or more visual features 102A and the one or more keyword 103A for computing the visual similarity score and the textual similarity score for the input document 101. In an embodiment, the pre-trained multi-class classifier may be trained using the one or more reference visual features 102B and the one or more reference keywords 103B extracted from one or more documents filled with relevant contents, as well as using one or more non-filled documents of each of the plurality of predetermined document types 109. Further, the pre-trained multi-class classifier may be capable of auto-learning the one or more visual features 102A and the one or more keywords 103A of a document, whenever the document identification system 105 encounters a new document type.

In an embodiment, the best-match identification 221 module may be used for identifying the one or more best-match document types 111 among the plurality of predetermined document types 109 based on the relative similarity score 211 of the input document 101. The best-match identification module 221 may consider one or more of the plurality of predetermined document types 109 to be the one or more best-match document types 111 only when the relative similarity score 211 of the input document 101, with respect to the one or more of the plurality of predetermined document types 109 is higher than a threshold similarity score.

In an embodiment, the document type identification module 223 may be responsible for identifying the type 117 of the input document 101. The document type identification module 223 may compare the one or more visual features 102A and the one or more keywords 103A extracted from the input document 101 with the one or more global characteristics 113 and the one or more local characteristics 115 associated with each of the one or more best-match document types 111 to identify one among the one or more best-match document types 111 as the document type 117 of the input document 101.

FIG. 3 is an exemplary representation of an input document 101 having one or more visual features 102A and one or more keywords 103A. As an example, the one or more visual features 102A which may be extracted from the input document 101 may include, without limiting to, a rectangular space on top-right corner of the input document 101 for affixing the photograph, a label or title of the input document 101 at top-center portion of the input document 101, a table having 5 columns and 4 rows on bottom half of the input document 101, a sequence of 11 text boxes on the top-center portion of the input document 101, and the like. Similarly, the one or more keywords 103A that may be extracted from the input document 101 may include, without limiting to, phrases such as—‘Name of the applicant’, ‘address’, ‘contact number’ ‘date of birth’, ‘academic qualification’, signature of the applicant’ and the like. In an embodiment, each of the one or more visual features 102A and each of the one or more keywords 103A, extracted from the input document 101, may be compared with one or more reference visual features 102B and with one or more reference keywords 103B, extracted from plurality of predetermined documents 109, for computing a relative similarity score 111 for the input document 101.

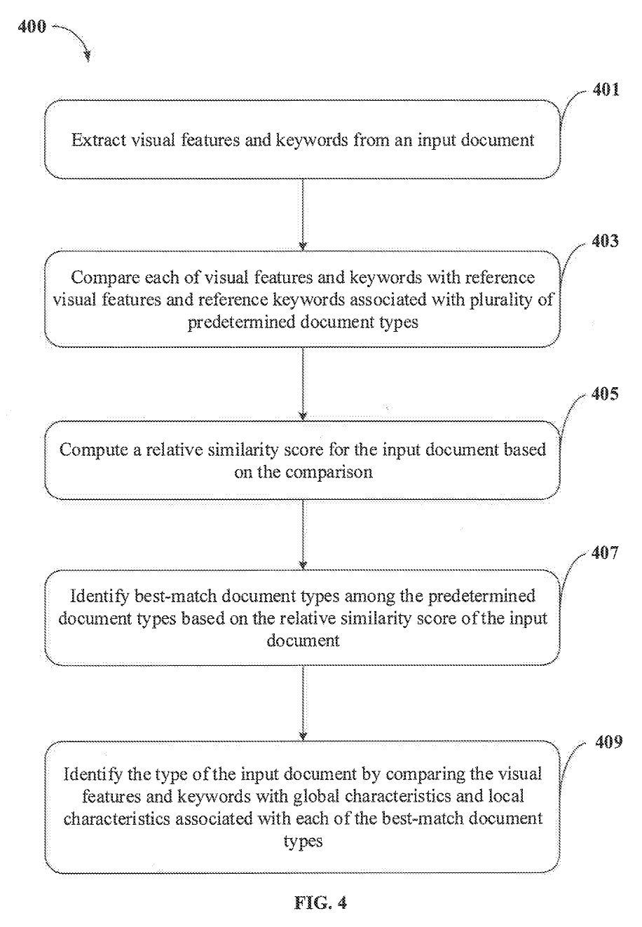

FIG. 4 shows a flowchart illustrating a method of identifying type of a document in real-time in accordance with some embodiments of the present disclosure.

As illustrated in FIG. 4, the method 400 includes one or more blocks illustrating a method of identifying type of a document in real-time using a document identification system 105, for example, the document identification system 105 shown in FIG. 1. The method 400 may be described in the general context of computer executable instructions. Generally, computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the method 400 includes extracting, by the document identification system 105, one or more visual features 102A and one or more keywords 103A from an input document 101. As an example, the one or more visual features 102A may include, without limiting to, location and pattern of each of lines, keywords, text boxes, check boxes, box sequences, tables, labels and logos in the input document 101. Similarly, the one or more keywords 103A may include, without limiting to, one or more words, phrases or other textual characters present in the input document 101. In an embodiment, the one or more visual features 102A and the one or more keywords 103A may be extracted from the input document 101 using a predetermined character recognition technique configured in the document identification system 105.

At block 403, the method 400 includes comparing each of the one or more visual features 102A and each of the one or more keywords 103A with one or more reference visual features 102B and one or more reference keywords 103B associated with plurality of predetermined document types 109. In an embodiment, the plurality of predetermined document types 109 may be stored in the document identification system 105.

At block 405, the method 400 includes computing a relative similarity score 211 for the input document 101 based on the comparison performed at block 403. The relative similarity score 211 of the input document 101 may indicate relative similarity of the input document 101 with each of the plurality of predetermined document types 109. In an embodiment, the relative similarity score 211 for the input document 101 may be computed by aggregating a visual similarity score and a textual similarity score of the input document 101. As an example, the visual similarity score may be computed by comparing each of the one or more visual features 102A extracted from the input document 101 with one or more reference visual features 102B of each of the plurality of predetermined document types 109. Similarly, the textual similarity score may be computed by comparing each of the one or more keywords 103A extracted from the input document 101 with one or more reference keywords 103B associated with each of the plurality of predetermined document types 109.

In an embodiment, the visual similarity score and the textual similarity score for the input document 101 may be computed using a pre-trained multi-class classifier configured in the document identification system 105. Further, the pre-trained multi-class classifier may be trained using one or more reference visual features 102B and one or more reference keywords 103B extracted from one or more documents filled with contents and one or more non-filled documents of each the of the plurality of predetermined document types 109.

At block 407, the method 400 includes identifying one or more best-match document types 111 for the input document 101, among the plurality of predetermined document types 109, based on the relative similarity score 211 of the input document 101. In an embodiment, one or more of the plurality of predetermined document types 109 may be identified as the one or more best-match document types 111 when the relative similarity score 211 of the input document 101 is higher than a threshold similarity score.

At block 409, the method 400 includes identifying the type 117 of the input document 101 by comparing the one or more visual features 102A and the one or more keywords 103A extracted from the input document 101 with one or more global characteristics 113 and one or more local characteristics 115 associated with each of the one or more best-match document types 111. As an example, the one or more global characteristics 113 may indicate presence and count of each of lines, keywords, text boxes, check boxes, box sequences, tables, labels and logos in the one or more best-match document types 111. Similarly, the one or more local characteristics 115 may indicate location and pattern of each of one or more global characteristics 113 in the one or more best-match document types 111.

Computer System

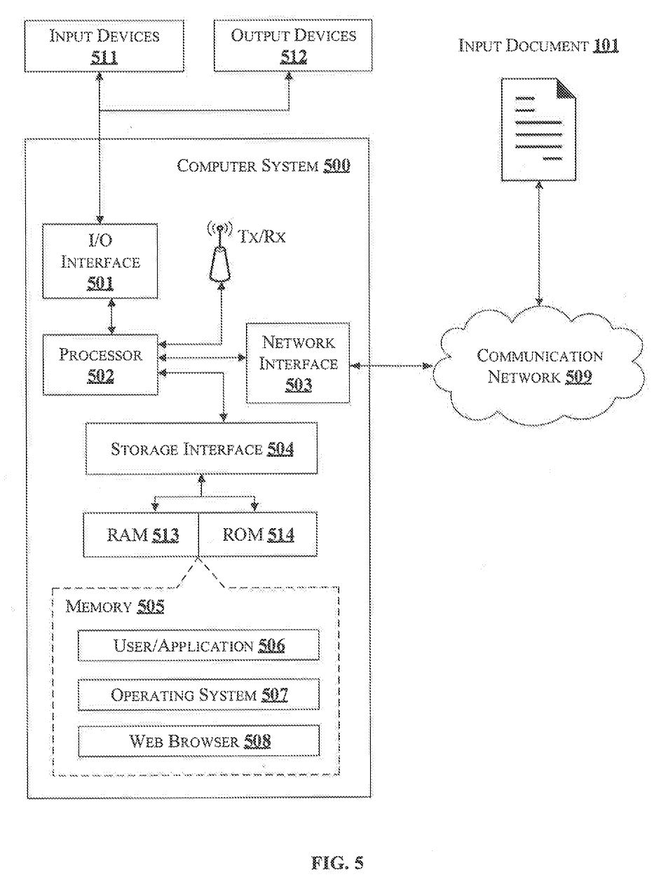

FIG. 5 illustrates a block diagram of an exemplary computer system 500 for implementing embodiments consistent with the present disclosure. In an embodiment, the computer system 500 may be document identification system 105 shown in FIG. 1, which may be used for identifying type of a document in real-time. The computer system 500 may include a central processing unit (“CPU” or “processor”) 502. The processor 502 may comprise at least one data processor for executing program components for executing user- or system-generated business processes. A user may include a person, a user in the computing environment 100, and the like. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 501, the computer system 500 may communicate with one or more I/O devices 511 and 512. In some implementations, the I/O interface 501 may be used to connect to a one or more sources of the input document 101.

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 503 and the communication network 509, the computer system 500 may receive the input document 101, whose type needs to be identified by the document identification system 105.

In an implementation, the communication network 509 can be implemented as one of the several types of networks, such as intranet or Local Area Network (LAN) and such within the organization. The communication network 509 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application interface 506, an operating system 507, a web browser 508, and the like. In some embodiments, computer system 500 may store user/application data 506, such as the data, variables, records, etc. as described in this invention. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

The user interface 506 may facilitate display, execution, interaction, manipulation, or operation of program components through textual or graphical facilities. For example, the user interface 506 may provide computer interaction interface elements on a display system operatively connected to the computer system 500, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., Aero, Metro, etc.), web interface libraries (e.g., ActiveX®, JAVA®, JAVASCRIPT®, AJAX, HTML, ADOBE® FLASH®, etc.), or the like.

The web browser 508 may be a hypertext viewing application. Secure web browsing may be provided using Secure Hypertext Transport Protocol (HTTPS), Secure Sockets Layer (SSL), Transport Layer Security (TLS), and the like. The web browsers 508 may utilize facilities such as AJAX, DHTML, ADOBE® FLASH®, JAVASCRIPT®, JAVA®, Application Programming Interfaces (APIs), and the like. Further, the computer system 500 may implement a mail server stored program component. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, that is, non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein

In an embodiment, the present disclosure discloses a method for identifying type of a document in real-time prior to digitization of the input document, and thereby helps in storing the input document in appropriate formats and correct folders/directors after digitizing the input document.

In an embodiment, the method of present disclosure helps in accurate recognition of type of a document by correlating the textual features, as well as the visual features of the document, including complex non-linear visual patterns of the document.

In an embodiment, the method of present disclosure uses a pre-trained, multi-class classifier such as Siamese Network, which could be trained with very few training samples of each document type, and can recognize the type of document with near human accuracy.

In an embodiment, the document identification system and the method of present disclosure eliminate manual intervention involved in identifying and segregating large number of legacy forms by automatically recognizing the type of documents.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Environment |
| 101 | Input document |
| 102A | Visual features of the input document |
| 103A | Keywords in the input document |
| 102B | Reference visual features |
| 103B | Reference keywords |
| 105 | Document identification system |
| 109 | Predetermined document types |
| 111 | Best-match document types |
| 113 | Global characteristics |
| 115 | Local characteristics |
| 117 | Type of the input document |
| 201 | I/O interface |
| 203 | Processor |
| 205 | Memory |
| 207 | Data |
| 209 | Modules |
| 211 | Relative similarity score |
| 213 | Other data |
| 215 | Feature extraction module |
| 217 | Comparison module |
| 219 | Similarity score computation module |
| 221 | Best-match identification module |
| 223 | Document type identification module |
| 225 | Other modules |
| 500 | Exemplary computer system |
| 501 | I/O Interface of the exemplary computer system |
| 502 | Processor of the exemplary computer system |
| 503 | Network interface |
| 504 | Storage interface |
| 505 | Memory of the exemplary computer system |
| 506 | User/Application |
| 507 | Operating system |
| 508 | Web browser |
| 509 | Communication network |
| 511 | Input devices |
| 512 | Output devices |
| 513 | RAM |
| 514 | ROM |

What is claimed is:

1. A method for identifying type of a document in real-time, the method comprising:
extracting, by a document identification system (105), one or more visual features (102A) and one or more keywords (103A) from an input document (101);
comparing, by the document identification system (105), each of the one or more visual features (102A) and each of the one or more keywords (103A) with one or more reference visual features (102B) and with one or more reference keywords (103B) associated with a plurality of predetermined document types (109);
computing, by the document identification system (105), a relative similarity score (211) for the input document (101) based on the comparison;
identifying, by the document identification system (105), one or more best-match document types (111), among the plurality of predetermined document types (109), for the input document (101) based on the relative similarity score (211) of the input document (101); and
identifying, by the document identification system (105), the type (117) of the input document (101) by comparing the one or more visual features (102A) and the one or more keywords (103A) extracted from the input document (101) with one or more global characteristics (113) and one or more local characteristics (115) associated with each of the one or more best-match document types (111).

2. The method as claimed in claim 1, wherein the one or more visual features (102A) and the one or more keywords (103A) are extracted from the input document (101) using a predetermined character recognition technique configured in the document identification system (105).

3. The method as claimed in claim 1, wherein the one or more visual features (102A) comprises location and pattern of each of lines, keywords, text boxes, check boxes, box sequences, tables, labels and logos in the input document (101).

4. The method as claimed in claim 1, wherein computing the relative similarity score (211) for the input document (101) comprises:
assigning a visual similarity score for the input document (101) based on comparison of each of the one or more visual features (102A) extracted from the input document (101) with one or more reference visual features (102B) of each of the plurality of predetermined document types (109);
assigning a textual similarity score for the input document (101) based on comparison of each of the one or more keywords (103A) extracted from the input document (101) with one or more reference keywords (103B) associated with each of the plurality of predetermined document types (109); and
aggregating the visual similarity score and the textual similarity score for obtaining the relative similarity score (211) of the input document (101).

5. The method as claimed in claim 4, wherein the visual similarity score and the textual similarity score for the input document (101) are assigned using a pre-trained multi-class classifier configured in the document identification system (105).

6. The method as claimed in claim 5, wherein the pre-trained multi-class classifier is trained using one or more visual features (102A) and one or more keywords (103A) extracted from one or more documents filled with contents and one or more non-filled documents of each of the plurality of predetermined document types (109).

7. The method as claimed in claim 1, wherein the relative similarity score (211) of the input document (101) indicates relative similarity of the input document (101) with each of the plurality of predetermined document types (109).

8. The method as claimed in claim 1, wherein one or more of the plurality of predetermined document types (109) are identified as the one or more best-match document types (111) when the relative similarity score (211) of the input document (101) is higher than a threshold similarity score.

9. The method as claimed in claim 1, wherein the one or more global characteristics (113) indicate presence and count of each of lines, keywords, text boxes, check boxes, box sequences, tables, labels and logos in the one or more best-match document types (111).

10. The method as claimed in claim 1, wherein the one or more local characteristics (115) indicate location and pattern of each of one or more global characteristics (113) in the one or more best-match document types (111).

11. A document identification system (105) for identifying type of a document in real-time, the document identification system (105) comprising:
a processor (203); and
a memory (205), communicatively coupled to the processor (203), wherein the memory (205) stores processor-executable instructions, which on execution cause the processor (203) to:
extract one or more visual features (102A) and one or more keywords (103A) from an input document (101);
compare each of the one or more visual features (102A) and each of the one or more keywords (103A) with one or more reference visual features (102B) and with one or more reference keywords (103B) associated with a plurality of predetermined document types (109);
compute a relative similarity score (211) for the input document (101) based on the comparison;
identify one or more best-match document types (111), among the plurality of predetermined document types (109), for the input document (101) based on the relative similarity score (211) of the input document (101); and
identify the type (117) of the input document (101) based on comparison of the one or more visual features (102A) and the one or more keywords (103A) extracted from the input document (101) with one or more global characteristics (113) and one or more local characteristics (115) associated with each of the one or more best-match document types (11).

12. The document identification system (105) as claimed in claim 11, wherein the processor (203) extracts the one or more visual features (102A) and the one or more keywords (103A) from the input document (101) using a predetermined character recognition technique configured in the document identification system (105).

13. The document identification system (105) as claimed in claim 11, wherein the one or more visual features (102A) comprises location and pattern of each of lines, keywords, text boxes, check boxes, box sequences, tables, labels and logos in the input document (101).

14. The document identification system (105) as claimed in claim 11, wherein to compute the relative similarity score (211) for the input document (101), the processor (203) is configured to:
assign a visual similarity score for the input document (101) based on comparison of each of the one or more visual features (102A) extracted from the input document (101) with one or more reference visual features (102B) of each of the plurality of predetermined document types (109);
assign a textual similarity score for the input document (101) based on comparison of each of the one or more keywords (103A) extracted from the input document (101) with one or more reference keywords (103B) associated with each of the plurality of predetermined document types (109); and
aggregate the visual similarity score and the textual similarity score to obtain the relative similarity score (211) of the input document (101).

15. The document identification system (105) as claimed in claim 14, wherein the processor (203) assigns the visual similarity score and the textual similarity score for the input document (101) using a pre-trained multi-class classifier configured in the document identification system (105).

16. The document identification system (105) as claimed in claim 15, wherein the processor (203) trains the pre-trained multi-class classifier using one or more visual features (102A) and one or more keywords (103A) extracted from one or more documents filled with contents, and one or more non-filled documents of each of the plurality of predetermined document types (109).

17. The document identification system (105) as claimed in claim 11, wherein the relative similarity score (211) of the input document (101) indicates relative similarity of the input document (101) with each of the plurality of predetermined document types (109).

18. The document identification system (105) as claimed in claim 11, wherein the processor (203) identifies one or more of the plurality of predetermined document types (109) as the one or more best-match document types (111), when the relative similarity score (211) of the input document (101) is higher than a threshold similarity score.

19. The document identification system (105) as claimed in claim 11, wherein the one or more global characteristics (113) indicate presence and count of each of lines, keywords, text boxes, check boxes, box sequences, tables, labels and logos in the one or more best-match document types (111).

20. The document identification system (105) as claimed in claim 11, wherein the one or more local characteristics (115) indicate location and pattern of each of one or more global characteristics (113) in the one or more best-match document types (111).

21. A non-transitory computer readable medium including instructions stored thereon that when processed by at least one processor (203) cause a document identification system (105) to perform operations comprising:
extracting one or more visual features (102A) and one or more keywords (103A) from an input document (101);
comparing each of the one or more visual features (102A) and each of the one or more keywords (103A) with one or more reference visual features (102B) and with one or more reference keywords (103B) associated with a plurality of predetermined document types (109);
computing a relative similarity score (211) for the input document (101) based on the comparison;
identifying one or more best-match document types (111), among the plurality of predetermined document types (109), for the input document (101) based on the relative similarity score (211) of the input document (101); and
identifying the type (117) of the input document (101) by comparing the one or more visual features (102A) and the one or more keywords (103A) extracted from the input document (101) with one or more global characteristics (113) and one or more local characteristics (115) associated with each of the one or more best-match document types (111).
